(19) United States
(12) Patent Application Publication
(10) Pub. No.: US 2001/0024297 A1
(43) Pub. Date: Sep. 27, 2001

(54) Image encoding apparatus, method and medium

(76) Inventors: Takefumi Nagumo, Tokyo (JP); Yoichi Yagasaki, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/775,157

(22) Filed: Feb. 1, 2001

(30) Foreign Application Priority Data
Feb. 2, 2000 (JP) P2000-030275

(51) Int. Cl. H04N 1/41

(52) U.S. Cl. 358/426

(57) ABSTRACT

Desired shape information is selected from a shape information template that holds the shape information corresponding to a plurality of shape information images, and in an encoder, the MPEG4 image encoding bit stream is generated, using the selected shape information and the texture image (original image, etc.) data.

### BACKGROUND OF THE INVENTION

1. Technical Field

The present invention relates to an image encoding apparatus, method and medium. More specifically, the present invention relates to an image encoding apparatus, method and medium suitably used for recording data in a recording medium such as an optical magnetic disk, a magnetic tape or a flash memory, and reproducing this to display on a display unit or the like, or for transmitting data from a sending side to a receiving side via a transmission line such as a video teleconference system, Internet or a television equipment, and receiving and displaying this on the receiving side.

2. Prior Art

FIG. 1 shows a schematic construction of a conventional image encoding apparatus.

FIG. 1 shows one example of a conventional image encoding apparatus that adopts a shape coding method for coding texture image data (hereinafter properly referred to as “texture information”) comprising image data such as usual luminance and color difference data or R (red), G (green) and B (blue) data, as well as for coding shape information, being allocated information of an object in an image.

That is to say, the image encoding apparatus shown in FIG. 1 is an encoding apparatus for encoding the shape information together with the texture image data, wherein the shape information of the object is prepared using any means in the encoding apparatus from the input original image 120, and the prepared shape information is encoded together with the image data of a texture image 121 (texture information) obtained from the original image 120.

A description will be given here by using a so-called MPEG4 video encoding method (ISO/IEC 14496-2) as the image encoding method capable of encoding of texture information and shape information. However, this is only an example, and the present invention is not limited to the MPEG4 encoding, and is also applicable to general encoding methods having shape information.

In FIG. 1, the image data of the original image 120 consists of usual luminance and color difference data, or R, G and B data, and the image data is input to the object information allocator 110.

The object information allocator 110 cuts out the shape of an object in the input original image 120, and generates and outputs shape information representing only the allocated object shape. When the shape information in which only the shape of an object 123 in the original image 120 is cut out is expressed as one image, the image looks like the shape information image 122 in FIG. 1.

Here, for generating the shape information expressed as the above shape information image 122, in general, a method referred to as chromakey is used. The chromakey refers to a method which enables discrimination of an object in an image, by taking a picture of an image in a room having, for example, a blue floor or wall at the time of image shooting, and designating a pixel having a blue component in the image data as the background portion and a pixel having components other than blue as the foreground portion. Other methods other than the chromakey include a luminance key for discriminating the foreground and background portions of the image based on the pixel value of luminance, a method in which the foreground portion and the background portion are specified on the image of the first frame, and in the frames thereafter, the foreground portion and the background portion in the image are discriminated (pursued) based on the first frame information, and a method for detecting edge information of an object using a filter or the like.

The shape information generated by the object information allocator 110 by using such a method is transmitted to the MPEG4 encoder 111.

Moreover, image data (texture information) of the texture image 121 obtained from the original image 120 is also output from the object information allocator 110, and transmitted to the MPEG4 encoder 111 together with the shape information. As the texture image data (texture information), the image data of the original image 120 input to the object information allocator 110 may be directly output. Furthermore, for example, in the case where after an object has been cut out, only the foreground portion is encoded, the pixel value in the foreground portion may be replaced with another pixel value, or the image data may be properly converted data by using a filter or the like, in order to reduce the post-process.

The MPEG4 encoder 111 receives the texture image data (texture information) and the shape information output from the object information allocator 110 as the input thereof, and converts these information (image data) to a bit stream in accordance with the MPEG4 video encoding method. The bit stream obtained by the encoding is stored in a storage medium 112, or recorded in a memory 113 such as a hard disk, or directly transmitted to a communication network such as Internet, as the MPEG4 encoded bit stream.

With the conventional image encoding apparatus shown in FIG. 1, as described above, shape information is prepared from the image data of the original image 120 comprising luminance and color difference data or R, G and B data or the like, by using various object allocation method such as chromakey, luminance key described above.

However, as the method of object allocation, for example, when the above-described chromakey method is used, there is a restriction that shooting must be carried out in a studio or the like having a background with a color difference (that is, blue background).

Moreover, for example, when using the method in which the foreground portion and the background portion are specified on the image of the first frame, and in the frames thereafter, the foreground portion and the background portion in the image are discriminated based on the first frame information, that is, a method in which shape information is provided with respect to the image of the first frame, and this is pursued, a huge amount of operation is required for obtaining the shape information of remaining frames by pursuing the shape information with respect to the first frame. In addition, in order to provide the shape information with respect to the image of the first frame, for example, an operation such that an operator specifies the object shape manually becomes necessary, making the operation very complicated.

Furthermore, with the luminance key method in which the foreground and background portions of the image are discriminated based on the pixel value of luminance, or the method in which the edge information of an object is detected by using a filter or the like, for example, it is quite difficult to allocate only a desired image portion in the image (for example, the image portion of an optional object 123 in the original image 120 in FIG. 1).

### BRIEF SUMMARY OF THE INVENTION

In view of the above situation, it is, therefore, an object of the present invention to provide an image encoding apparatus, method and medium, in which when an encoded bit stream is generated from texture information and shape information, there is no restriction at the time of image shooting, the amount of calculation and the number of processes performed by an operator for generating the shape information can be reduced, and shape information regarding a desired image portion in the image can be generated.

A first object of the present invention is to provide an image encoding apparatus for encoding an image signal to generate an image encoded bit stream, comprising:

a shape information memory for storing a plurality of shape information;

selection means for selecting desired shape information from the shape information memory; and

encoding means for generating image encoded bit stream corresponding to a predetermined image format, from the selected shape information and the image signal.

A second object of the present invention is to provide an image encoding method for encoding an image signal to generate an image encoded bit stream, comprising:

a step of selecting desired shape information from a shape information memory that stores a plurality of shape information; and

an encoding step of generating an image encoded bit stream corresponding to a predetermined image format, from the selected shape information and the image signal.

A third aspect of the present invention is to provide a recording medium in which a program for encoding an image signal and generating an image encoded bit stream is stored, the program comprising:

a step of selecting desired shape information from a shape information memory that stores a plurality of shape information; and

an encoding step of generating an image encoded bit stream corresponding to a predetermined image format, from the selected shape information and the image signal.

In the present invention, an image encoded bit stream corresponding to a predetermined image encoding format is generated from desired shape information selected from a plurality of shape information prepared in advance and an image signal, to thereby reduce processing related to shape information generation and shape information encoding at the time of adding shape information to an image signal, which, for example, does not have shape information, to generate an image encoded bit stream. That is to say, the amount of calculation and the number of processes performed by the operator can be reduced. Moreover, there is no restriction at the time of image shooting, and it is also possible to generate shape information regarding a desired image portion in the image.

### BRIEF DESCRIPTION OF THE SEVERAL VIEWS OF THE DRAWING

FIG. 1 is a diagram showing a schematic construction of a conventional image encoding apparatus;

FIG. 2 is a diagram showing a schematic construction of an image encoding apparatus of a first embodiment of the present invention;

FIG. 3 is a diagram showing a schematic construction of an image encoding apparatus of a second embodiment of the present invention;

FIG. 4 is a diagram showing a schematic construction of an image encoding apparatus of a third embodiment of the present invention;

FIG. 5 is a diagram used for explaining shape information (at the time of INTRA encoding) transmitted in the MPEG4 video encoding method;

FIG. 6 is a diagram used for explaining interframe prediction at the time of encoding the shape information in the MPEG4 video encoding method;

FIG. 7 is a diagram used for explaining shape information (at the time of INTER encoding) transmitted in the MPEG4 video encoding method;

FIG. 8 is a diagram showing a configuration example of a shape bit stream read-in type MPEG4 encoder; and

FIG. 9 is a diagram used for explaining separation and synthesis of the texture encoded data and the shape information encoded data.

### DETAILED DESCRIPTION OF THE INVENTION

Preferred embodiments of the present invention will now be described with reference to the drawings.

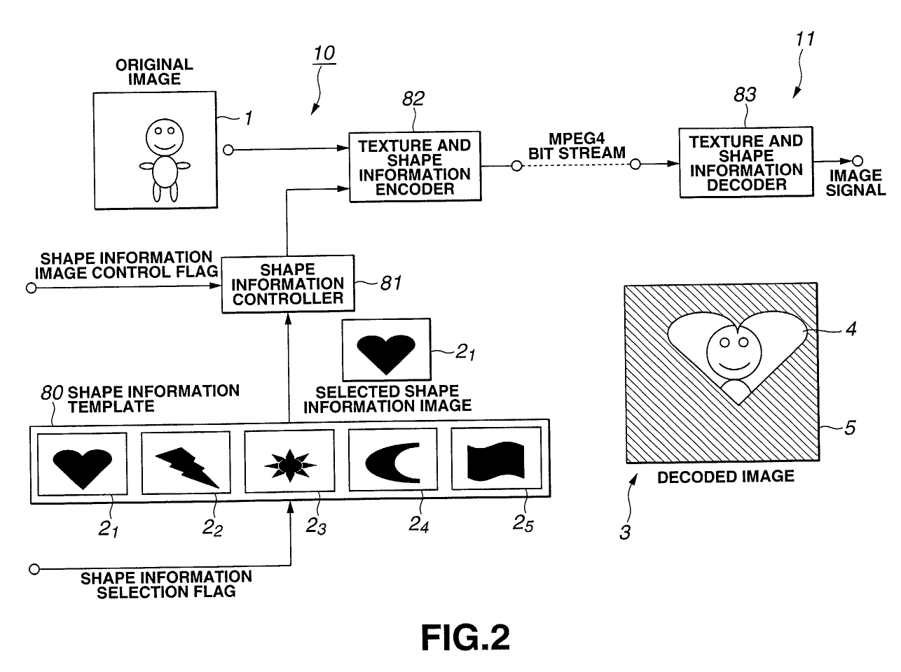

FIG. 2 shows a schematic construction of an image encoding apparatus 10 in the first embodiment of the present invention. In FIG. 2, a decoding apparatus 11 for decoding the MPEG4 bit stream output from the image encoding apparatus 10 in this embodiment is also shown.

In FIG. 2, the image data of an original image 1 comprising luminance and color difference data or R, G and B data is input to an encoder 82 as the texture image data.

The shape information template 80 holds shape information corresponding to a plurality of shape information images 2₁, 2₂, 2₃, 2₄, 2₅, . . . generated in advance, and desired image information specified by a shape information selection flag is selected from among these plurality of shape information, and the selected shape information (in the example of FIG. 2, the shape information of the shape information image 2₁) is output. The plurality of shape information held by the shape information template 80 may be held as data (pixel data) in the state that encoding has not been performed, or as data in the state that encoding has been performed in accordance with an optional encoding format in advance. In the case where the shape information is encoded in accordance with an optional encoding format and held in the shape information template 80, the shape information encoded in accordance with the optional encoding format is decoded corresponding to the optional encoding format and output, or converted to a format capable of inputting to an encoder 82 in the subsequent stage, at the time of being output from the shape information template 80. In this case, the conversion means for performing decoding or format conversion is provided in the output stage of the shape information template 80.

The shape information selected and output from the shape information template 80 is transmitted to a shape information controller 81.

A shape information image control flag is input to the shape information controller 81, according to need. When the shape information image control flag is input, the shape information controller 81 adjusts the position, size or the like of the shape information image 2 corresponding to the shape information, in response to the shape information image control flag. That is to say, as the adjustment of the position of the shape information image 2 in the shape information controller 81 in this case, for example, adjustment such that the shape information image 2 is arranged (moved) to a desired position with respect to the original image 1 is performed, and as the adjustment of the size, the shape information image 2 is adjusted so as to be enlarged, reduced, deformed or the like. The shape information after having subjected to adjustment of position, size or the like of the shape information image 2 is transmitted to the encoder 82.

The encoder 82 receives the texture image data (texture information) and the shape information as the input thereof, and converts these data (image data) to an image encoded bit stream in accordance with the MPEG4 video encoding method as a predetermined image-encoding format. The image encoded bit stream obtained by this encoding is stored in a storage medium (not shown), or recorded in a memory such as a hard disk or the like, or directly transmitted to a communication network such as Internet, as the MPEG4 bit stream.

The stored, or recorded or transmitted MPEG4 bit stream as described above is decoded by a decoder 83 of the image decoding apparatus 11. For example, in the image encoding apparatus 10 in FIG. 2, if the shape information image 2₁ is selected from the shape information template 80, and the position and the size of the shape information image 2₁ is adjusted in a part of an object 6 in the original image 1 (for example, near the head of the human-type object 6), the image obtained by decoding the MPEG4 bit stream by the image decoding apparatus 11, which has been obtained by encoding the shape information image 2₁ and the texture image data of the original image 1, becomes like the decoded image 3 in FIG. 2. In the case of the decoded image 3 in FIG. 2, the area 5 in the decoded image 3 is handled as the outside of the image object 4, and only the image portion in the image area 4 is decoded.

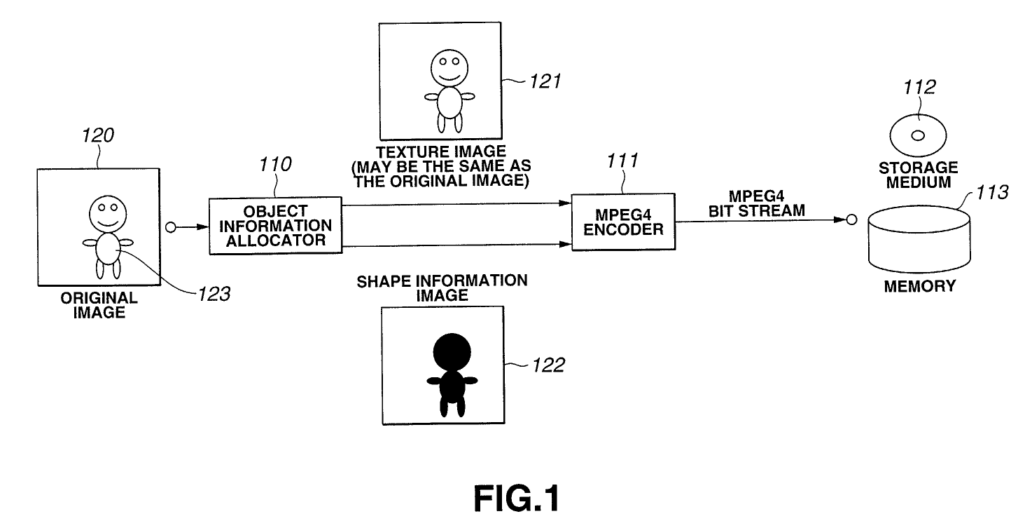

As described above, in the image encoding apparatus in the first embodiment of the present invention, the shape information is not prepared from the image data of the original image 1, but is formed by selecting desired shape information from a group of shape information held in advance in the shape information template 80, and forming an encoded bit stream from the shape information and the texture image data, thereby enabling reduction of extractive work such as allocation of an object from the texture image data of the input original image, as in the construction of the conventional example in FIG. 1. As a result, according to the first embodiment of the present invention, there is no restriction at the time of image shooting, as in the case where chromakey or the like is used for allocating the object portion in the original image. Moreover, at the time of image encoding, the amount of calculation and the number of processes performed by the operator for generating the shape information are hardly required, and it is also possible to easily obtain the shape information regarding the desired image portion in the image.

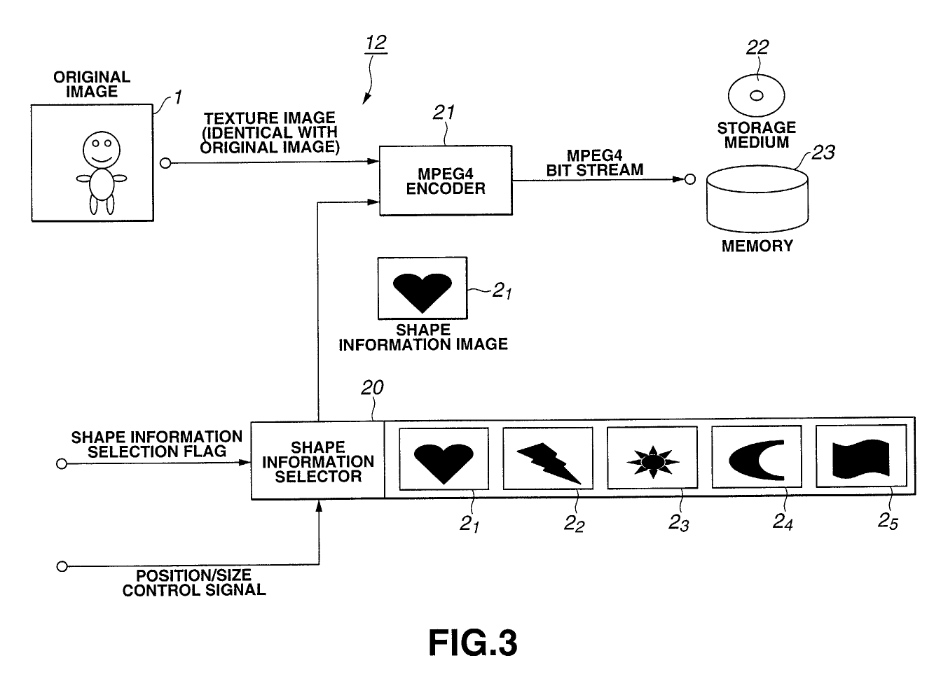

The schematic construction of an image encoding apparatus 12 in the second embodiment of the present invention is shown in FIG. 3.

In FIG. 3, the image data of the original image 1 comprising luminance and color difference data or R, G and B data is input to the MPEG4 encoder 21 as the texture image data.

Moreover, a shape information selector 20 holds shape information corresponding to a plurality of shape information images 2₁, 2₂, 2₃, 2₄, 2₅, . . . generated in advance, and desired image information specified by a shape information selection flag (in the example of FIG. 3, the shape information of the shape information image 21) is selected from among the plurality of shape information. The plurality of shape information held by the shape information selector 20 may be held as data (pixel data) in the state that encoding has not been performed, or as data in the state that encoding has been performed in accordance with an optional encoding format in advance. In the case where the shape information is encoded in accordance with an optional encoding format and held in the shape information selector 20, the shape information encoded in accordance with the optional encoding format is decoded corresponding to the optional encoding format and output, or converted to a format capable of inputting to an encoder 22 in the subsequent stage and output, at the time of being output from the shape information selector 20. In this case, the shape information selector 20 comprises the conversion means for performing decoding or format conversion.

In the case of the image encoding apparatus 12 in this second embodiment, position and size control data is also input, according to need, to the shape information selector 20. When the position and size control signal is input, the shape information selector 20 adjusts the position and the size of the shape information image 2 corresponding to the above-described selected shape information, in accordance with the position and size control signal, and outputs the adjusted shape information. That is to say, as the adjustment of position of the shape information image 2 in the shape information selector 20 in this case, for example, adjustment such that the shape information image 2 is arranged (moved) to a desired position with respect to the original image 1 is performed, and as the adjustment of the size, the shape information image 2 is adjusted so as to be enlarged, reduced, deformed or the like. The shape information after having subjected to adjustment of position, size or the like of the shape information image 2 is transmitted to the MPEG4 encoder 21.

The MPEG4 encoder 21 receives the texture image data (texture information) and the shape information as the input thereof, and converts these data (image data) to an image encoded bit stream in accordance with the MPEG4 video encoding method. The image encoded bit stream obtained by this encoding is stored in a storage medium 22, or recorded in a memory 23 such as a hard disk or the like, or directly transmitted to a communication network such as Internet, as the MPEG4 bit stream.

As described above, in the image encoding apparatus in the second embodiment of the present invention, the shape information is not prepared from the image data of the original image 1, but is formed by selecting desired shape information from a group of shape information held in advance in the shape information selector 20, and forming an encoded bit stream from the shape information whose position, size or the like has been adjusted and the texture image data. Thus, it is possible to reduce extractive work such as allocation of an object from the texture image data of the input original image, as in the construction of the conventional example in FIG. 1. As a result, according to the second embodiment of the present invention, there is no restriction at the time of image shooting, as in the case where chromakey or the like is used for allocating the object portion in the original image. Moreover, at the time of image encoding, the amount of calculation and the number of processes performed by the operator for generating the shape information are hardly required. It is also possible to easily obtain the shape information regarding the desired image portion in the image.

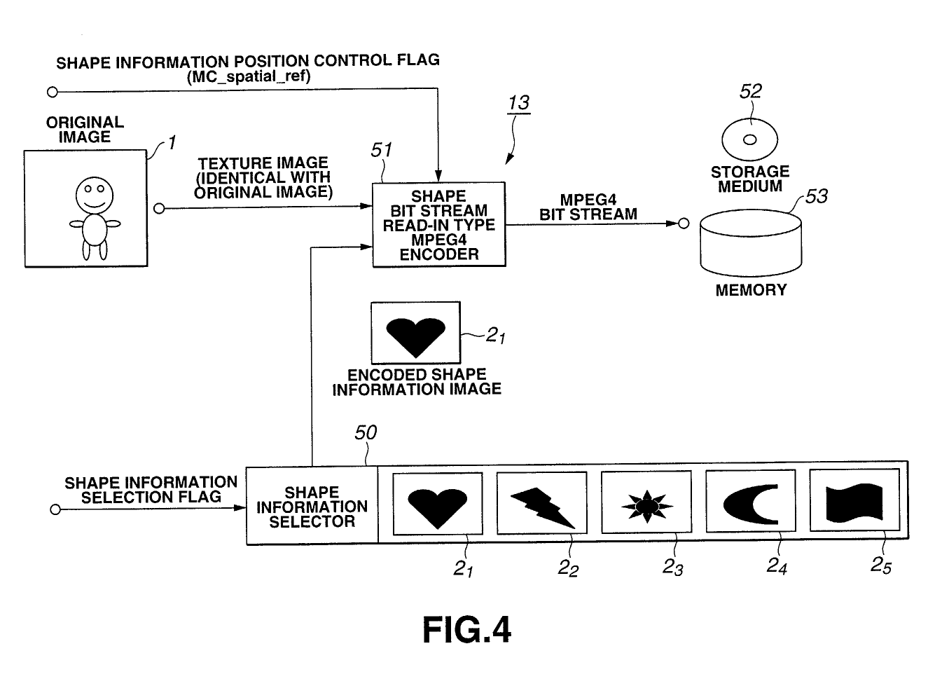

The schematic construction of an image encoding apparatus 13 in the third embodiment of the present invention is shown in FIG. 4.

The image encoding apparatus 13 in the third embodiment shown in FIG. 4 uses the property of a shape information encoding method in the MPEG4 video encoding method (ISO/IEC 14496-2), to make the shape information held in advance in a shape information selector 50 a bit stream encoded by the MPEG4 shape information encoding method or an encoding method corresponding thereto, as a predetermined image encoding format. As a result, the encoding processing of the shape information need not be performed in the MPEG4 encoder 51 in the subsequent stage, thereby enabling reduction of processing in the MPEG4 encoder 51.

Here, before specifically describing the construction of the third embodiment shown in FIG. 4, the encoding method of shape information in the MPEG4 video encoding method will be described.

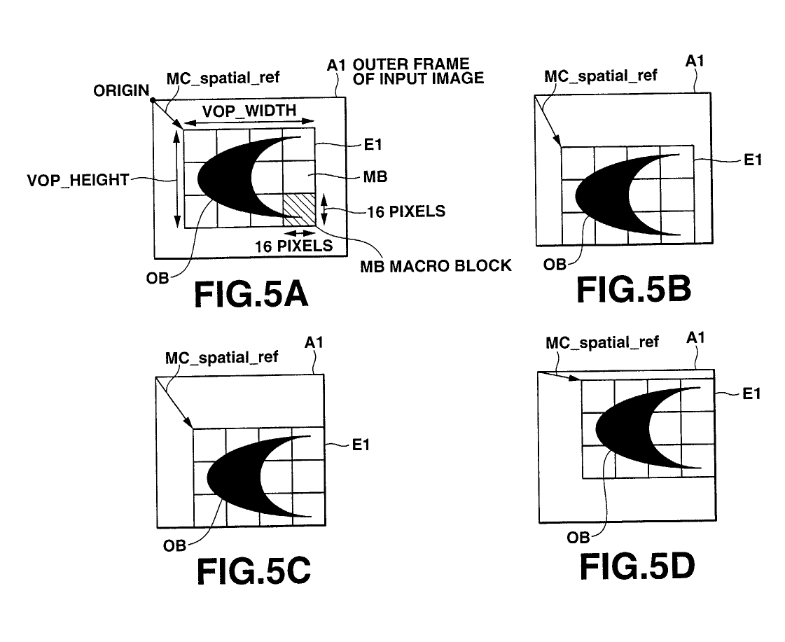

At the time of encoding the shape information in the MPEG4 video encoding method, the image area where encoding is performed is, for example, a rectangular area E1 within a thick line, as shown in FIG. 5(a).

The rectangular area El where encoding is performed may be an area including an image object OB cut out as the shape information, as shown in FIG. 5(a), and the size thereof is set so as to be a pixel value, being a multiple of 16, in both longitudinal and lateral directions (vertical and horizontal directions). The rectangular area El where the encoding is performed may be a rectangular area of a size having a pixel of a minimum multiple of 16 that can include the image object OB cut out as the shape information, or may be a rectangular area having the equal size as that of the input texture image or a rectangular area having a larger size. So long as it has a number of pixels, being a multiple of 16, in the longitudinal and lateral directions, the rectangular area El as the image area where the encoding is performed may be freely selected to any size.

Moreover, in FIGS. 5, 6 and 7, the outer frame of the image (picture frame A1) expressed by a thin line in the figure means a picture frame of the image input at the time of encoding the shape information. Here, the pixel position at the upper left corner of the picture frame A1 of the input image is designated as the origin, and the pixel position at the upper left corner in the above-described rectangular area El with respect to the origin is shown by a vector expressed by a value in the lateral and longitudinal directions, such as MC_spatial_ref. Moreover, as described above, the lateral width of the rectangular area El selected so as to have a number of pixels, being a multiple of 16, both in the longitudinal and lateral directions is expressed as VOP_WIDTH, and the longitudinal width is expressed as VOP_HEIGHT.

In the MPEG4 video encoding method, at the time of encoding of the texture information, the texture image is divided for every square area of 16 pixels, and encoding is performed for every square area of 16 pixels. Also at the time of encoding of the shape information, the shape information image is divided for every square area of 16 pixels, as in the case of encoding of the texture information, and encoding is performed for every square area of 16 pixels. That is to say, the above described shape information image is divided for every square area of 16 pixels existing in the spatial position equal to the texture image, and encoding is performed for every square area of 16 pixels. In addition, the lateral width VOP_WIDTH, the longitudinal width VOP_HEIGHT, and the vector MC_spatial ref are referred also at the time of encoding of the texture information. As described above, in the MPEG4 video encoding method, the shape information and the texture information respectively in the same spatial position are treated for every square area of the above described 16 pixels. The square area of the 16 pixels is referred to as a macro block (MB).

Moreover, encoding of the texture information in the MPEG4 video encoding method includes INTRA encoding in which encoding is performed using intraframe correlation, and INTER encoding in which encoding is performed using interframe correlation. At the time of encoding of the shape information, the INTRA encoding and the INTER encoding are performed.

The INTRA encoding of the shape information in the MPEG4 video encoding method will now be described, using FIG. 5.

As described above, with the MPEG4 video encoding method, the texture information is encoded in macro block units in the square area of 16 pixels, and encoding of the shape information is also performed in macro block units of square area of 16 pixels, as shown in FIG. 5(a). Data in the individual macro block MB is encoded, using encoded data of the shape information existing in the macro block MB, and the shape information data existing in the vicinity thereof.

On the other hand, the value of the above described vector MC_spatial_ref is not used at the time of encoding of the individual macro block MB. Therefore, for example, even if the value of vector MC_spatial_ref is respectively different as in FIG. 5(a), (b), (c) and (d), if the size of each rectangular area El shown in FIG. 5 (a) to (d) is the same, and the relative position of the image object OB and the rectangular area E1 is respectively identical, the data obtained by encoding the shape information within each macro block MB in FIG. 5(a) to (d) becomes identical. That is to say, as shown by the examples in FIG. 5(a) to (d), in the case where the size of the rectangular area E1 where encoding is performed is the same, and the relative position of the image object OB and the rectangular area El is identical, the shape information after encoding for a macro block unit is fixed determinately. However, VOP_header and VOP_Header combining the macro block data are not included within that range.

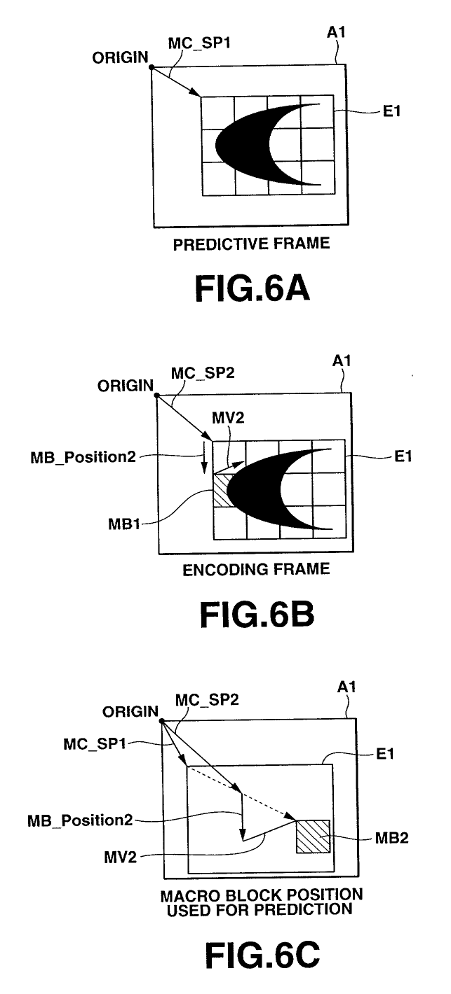

Next, the encoding method in the case of encoding the shape information by using interframe correlation will be described, with reference to FIG. 6.

FIG. 6(a) shows a predictive frame when the interframe prediction is performed. FIG. 6(b) shows an encoding frame for performing encoding and decoding, using the predictive frame in FIG. 6(a).

Here, the vector MC_spatial_ref in the case of FIG. 6(a) is designated as MC_SP1, and the vector MC_spatial_ref in the case of FIG. 6(b) is designated as MC_SP2. It is assumed that encoding of a macro block shown as MB1 in FIG. 6(b) is performed here. The motion compensating vector used for encoding the shape information within this macro block MB1 is also designated as MV2. Moreover, in FIG. 6(b), the vector from the pixel position at the upper left corner of the rectangular area E1 to the pixel position at the upper left corner of the macro block MB1 where encoding is to be performed is designated as MB_Position2.

At this time, the position of the predictive image (macro block MB2 in FIG. 6(c)) used for encoding of the macro block MB1 in FIG. 6(b) can be expressed as described below, with respect to the position from the origin at the upper left corner of the picture frame A1 of the input image:

MC_{—}SP2+MB_{—}Position2+MV2−MC_{—}SP1.

Moreover, when the reference position of the image used for the frame in FIG. 6(b) is considered with respect to the position at the upper left corner of the rectangular area El in FIG. 6(a) as the origin, the image (macro block MB2) at the position shown by an arrow with a dotted line in FIG. 6(c) is to be predicted. When the position from the coordinate at the upper left corner of the rectangular area E1 in FIG. 6(a) is shown, it can be expressed by the following expression:

MC_{—}SP2+MB_{—}Position2+MV2−MC_{—}SP1.

This indicates that even in the case of the macro block in which the position in the rectangular area E1 in FIG. 6(b) is the same, and the motion compensating vector has the same value, if the vector values of MC_SP1 and MC_SP2 are different, the position of the predictive image (macro block MB2) becomes different, and that when the vector values of MC_SP1 and MC_SP2 are the same, and when the same motion compensating vector is used with respect to a certain macro block within the rectangular area El, the position of the predictive image is fixed to the same one point.

Apart from this, with regard to the motion compensating vector of the shape information having a value other than 0, there is a case where the motion compensating vector of the texture information is used as the predictive value thereof at the time of encoding. This is a case where the motion compensating vector is not included in the shape information of the upper left, upper and upper right macro blocks in which encoding is now being performed. The encoded data of the motion compensating vector in the current situation information in this case is affected by the encoded information of the texture information. In this case, the above-described problem can be avoided by performing INTRA encoding.

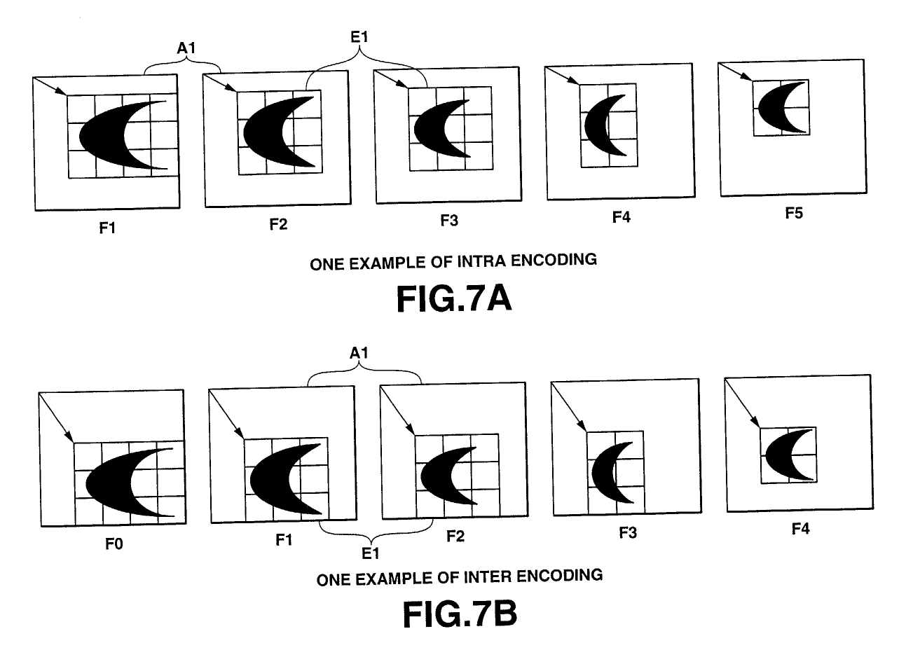

When encoding of shape information is performed with the restrictions (1) and (2) described below, considering the above situation, if the value of the shape information within the rectangular area E1 and the relative position of the shape information are identical, as shown in FIG. 6, then, even if the arranged positions of the shape information within each frame F1 to F5 are respectively different, the shape information data within corresponding macro blocks of corresponding frames are always identical. Here, FIG. 7(A) shows an example of INTRA encoding, and FIG. 7(B) shows an example of INTER encoding.

(1) For example, MC_spatial_ref is used in a common value for all frames.

(2) INTRA encoding is performed with respect to the macro block where the motion compensating vector of the texture information is used as the predictive value.

As a result, with regard to the shape information having been subjected to encoding using these restrictions (1) and (2), it becomes possible to decode the shape information having a constant value, regardless of the texture information and the value of MC_spatial_ref (provided that this value is made constant in a bit stream, at the time of using INTRA encoding).

The encoding processing of shape information at the time of MPEG4 encoding can be reduced, by encoding the shape information in advance, using theses restrictions (1) and (2) and storing the information as a bit stream.

That is to say, the third embodiment of the present invention shown in FIG. 4 realizes an image encoding apparatus 13, using the property of the above-described shape information encoding method.

In FIG. 4, the image data of the original image 1 comprising luminance and color difference data or R, G and B data is input to a shape bit stream (encoded bit stream of shape information) read-in type MPEG4 encoder 51 as the texture image data.

Moreover, a shape information selector 50 holds shape information corresponding to a plurality of shape information images 2₁, 2₂, 2₃, 2₄, 2₅, . . . generated in advance, with the shape information being encoded as a bit stream of MPEG4 shape (shape information). That is to say, in the case of this third embodiment, the shape information held in the shape information selector 50 is the encoded data, in which layers below the macro block are encoded in advance by the shape information encoding method in the MPEG4 video encoding method. The syntax above the macro block may not necessarily conform to the standard of the MPEG4 video encoding. It is assumed that the encoded shape information has been encoded in accordance with the above-described restrictions (1) and (2) at the time of encoding.

With the shape information selector 50, desired image information (in the example of FIG. 3, the encoded shape information of the shape information image 2₁) specified by a shape information selection flag is selected from among the plurality of shape information. The encoded data of the selected shape information is transmitted to the shape bit stream read-in type MPEG4 encoder 51.

The MPEG4 encoder 51 receives the texture image data (texture information) and the encoded data of the shape information as the input thereof, while a shape information position control flag is also input thereto, according to need. The shape information position control flag is required to be input, only when the position of the shape information is changed from the initial value, and it is assumed to have a common value for all frames.

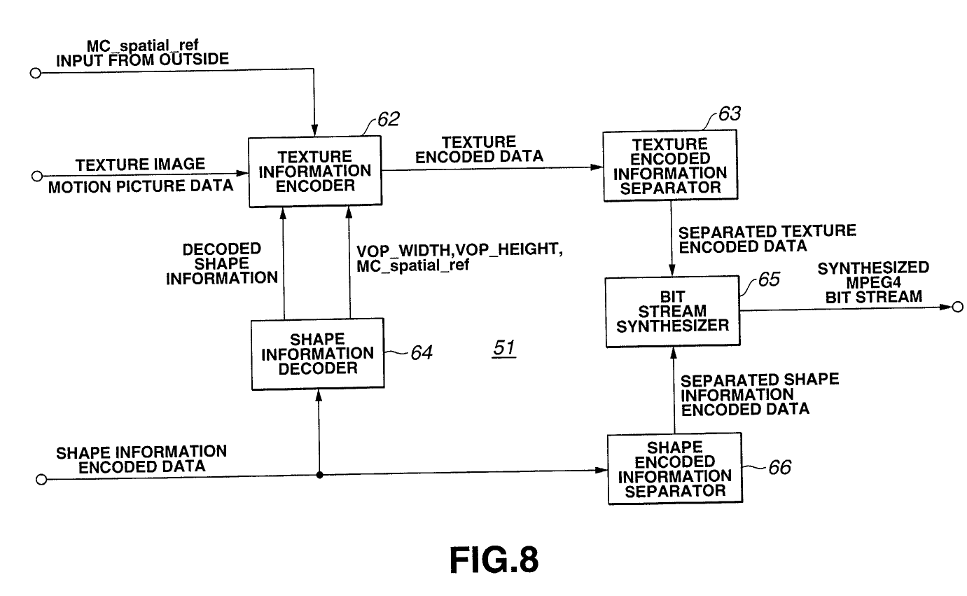

Here, the shape bit stream read-in type MPEG4 encoder 51 will be described, with reference to FIG. 8.

The encoded data of the shape information input to the shape bit stream read-in type MPEG4 encoder 51 is input to a shape information decoder 64 and a shape encoded information separator 66.

The shape information decoder 64 performs decoding of bit stream of the input encoded data of shape information, and inputs the shape information obtained by decoding to a texture information encoder 62. Moreover, at that time, the shape information decoder 64 transmits not only the above-described decoded shape information, but also information such as VOP_WIDTH, VOP_HEIGHT and MC_spatial_ref decoded at the time of decoding of the encoded data of shape information.

According to this embodiment, a description is made of a case where the shape information is encoded and held in the shape information selector 50. However, it is also possible to omit the processing in the shape information decoder 64 by storing, in the shape information selector 50, not only the encoded data of shape information, but also data of the decoded shape information images and information related thereto, such as VOP_WIDTH, VOP_HEIGHT and MC_spatial_ref, at the same time, and inputting the data of these shape information images and VOP_WIDTH, VOP_HEIGHT and MC_spatial_ref directly into the texture information encoder 62.

The texture information encoder 62 performs encoding of texture information, using the image data of the input texture image, the decoded shape information data, VOP_WIDTH, VOP_HEIGHT and MC_spatial_ref. That is to say, the texture information encoder 62 performs encoding of header information required for decoding of the MPEG4 bit stream, and texture information in the macro block. The texture encoded data obtained by encoding in the texture information encoder 62 is transmitted to the texture encoded information separator 63.

Moreover, to this texture information encoder 62 of the MPEG4 encoder 51 is also input a shape information position control flag, according to need. That is to say, when the shape information position control flag is input from outside in order to change the arrangement position of the shape information image, the texture information encoder 62 rewrites MC_spatial_ref to a value of the shape information control flag, to thereby move the position of shape information based on the value of the shape information position control flag. As the vector MC_spatial_ref indicating the upper left position of the shape information, one included in the shape information may be directly used, or may be input from outside, if it is desired to particularly specify the position.

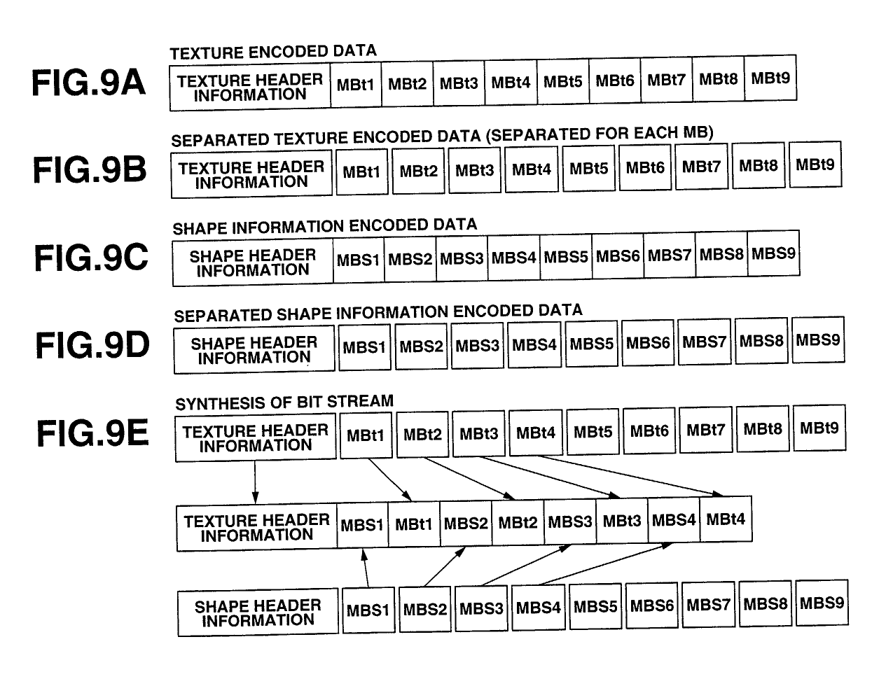

The texture encoded information separator 63 separates the texture encoded data as shown in FIG. 9(a) into the header information and other macro block data as shown in FIG. 9(b). These separated header information and macro block data are transmitted to the bit stream synthesizer 65.

Furthermore, the shape encoded information separator 66 receives the encoded data of shape information (shape) as shown in FIG. 9(c) as the input, and separates the shape information encoded data into the header information and other macro block data as shown in FIG. 9(d). These separated header information and macro block data are transmitted to a bit stream synthesizer 65.

The bit stream synthesizer 65 synthesizes the texture encoded data and the shape information encoded data separated and supplied respectively as described above, as shown in FIG. 9(e). As the header of the bit stream synthesized by the bit stream synthesizer 65, the header of the bit stream of the texture encoded data is used, and thereafter, the macro block of the shape information encoded data and the macro block of the texture encoded data are alternately inserted. The bit stream synthesizer 65 synthesizes such encoded data and outputs the synthesized bit stream.

The bit stream synthesized by the above described bit stream synthesizer 65 is output as the MPEG4 encoded bit stream from the shape bit stream read-in type MPEG4 encoder 51 shown in FIG. 4, and stored in a storage medium 52, or recorded in a memory 53 such as hard disk, or directly transmitted to a communication network such as Internet.

As described above, in the image encoding apparatus in the third embodiment of the present invention, the shape information is not formed from the image data of the original image 1, but is formed by selecting desired shape information from a group of shape information held in advance in the shape information selector 50, and forming an encoded bit stream from the shape information and the texture image data, thereby enabling reduction of extractive work such as allocation of an object from the texture image data of the input original image, as in the construction of the conventional example in FIG. 1. As a result, according to the third embodiment of the present invention, there is no restriction at the time of image shooting, as in the case where chromakey or the like is used for allocation of the object portion in the original image. Moreover, at the time of image encoding, the amount of calculation and the number of processes performed by the operator for generating the shape information are hardly required, and it is also possible to easily obtain the shape information regarding the desired image portion in the image. Furthermore, according to the third embodiment, the encoding processing of the shape information in the MPEG4 encoder is not required to thereby reduce the processing, by encoding the shape information in advance by means of the MPEG4 video encoding method and holding the encoded shape information.

In the above-described each embodiment, as the image encoding method, the MPEG4 has been described as an example, but the image encoding method is not limited to only the MPEG4 method, and the present invention is widely applicable to other image encoding methods that are capable of encoding the shape information. Moreover, in each embodiment of the present invention, the plurality of shape information and the encoded data thereof are held in the shape information template 80 in FIG. 2, in the shape information selector 20 in FIG. 3 and in the shape information selector 50 in FIG. 4, or may be also stored in a storage device or memory provided in the image encoding apparatus in each embodiment, or may be supplied from outside via a transmission medium, in response to a request from apparatus in each embodiment.

What is claimed is:

1. An image encoding apparatus for encoding an image signal to generate an image encoded bit stream, comprising:
a shape information memory for storing a plurality of shape information;
selection means for selecting desired shape information from said shape information memory; and
encoding means for generating image encoded bit stream corresponding to a predetermined image format, from said selected shape information and said image signal.

2. The image encoding apparatus according to claim 1, comprising adjustment means for adjusting the position and/or size of said selected shape information.

3. The image encoding apparatus according to claim 1, wherein said plurality of shape information are encoded in advance by an optional encoding format, said apparatus comprising decoding means for decoding said shape information and outputting said decoded shape information to said encoding means.

4. The image encoding apparatus according to claim 1, further comprising:
first separation means for separating said shape information into header information and predetermined encoding units;
second separation means for separating said image signal into header information and said predetermined encoding units; and
said encoding means generating an image encoded bit stream by alternately inserting said separated shape information and said separated image signals.

5. An image encoding method for encoding an image signal to generate an image encoded bit stream, comprising:
a step of selecting desired shape information from a shape information memory storing a plurality of shape information; and
an encoding step of generating an image encoded bit stream corresponding to a predetermined image format, from said selected shape information and said image signal.

6. The image encoding method according to claim 5, further comprising a step of adjusting the position and/or size of said selected shape information.

7. The image encoding method according to claim 5, wherein said plurality of shape information are encoded in advance by an optional encoding format; and
said method further comprising a decoding step of decoding said shape information and outputting said decoded shape information to said encoding means.

8. The image encoding method according to claim 5, further comprising:
a first separation step for separating said shape information into header information and predetermined encoding units;
a second separation step for separating said image signal into header information and said predetermined encoding units; and
said encoding step generating an image encoded bit stream by alternately inserting said separated shape information and said separated image signals.

9. A recording medium in which a program for encoding an image signal and generating an image encoded bit stream is stored, the program comprising:
a step of selecting desired shape information from a shape information memory storing a plurality of shape information; and
an encoding step of generating an image encoded bit stream corresponding to a predetermined image format, from said selected shape information and said image signal.
